(19) United States
(12) Patent Application Publication
(10) Pub. No.: US 2007/0220438 A1
(43) Pub. Date: Sep. 20, 2007

(54) Icon generating device, computer readable medium storing program for generating icon and method for generating icon

(75) Inventors: Hideki Okamoto, Kanagawa (JP); Kazuki Inami, Kanagawa (JP); Tomoyuki Ito, Kanagawa (JP); Hirokazu Mukai, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/714,919

(22) Filed: Mar. 7, 2007

(30) Foreign Application Priority Data
Mar. 8, 2006 (JP) P2006-062021

(51) Int. Cl. G06F 3/048

(52) U.S. Cl. 715/763

(57) ABSTRACT

An icon generating device includes a mode selecting section and an icon generating section. The mode selecting section allows a user to select one display mode for each data file from among a plurality of display modes. The icon generating section generates icon data of each data file, for displaying an icon of each data file in the display mode selected for each data file. The icon generating section outputs the generated icon data of each data file.

### CROSS-REFERENCE TO RELATED APPLICATIONS

This application is based on and claims priority under 35 U.S.C. §119 from Japanese Patent Application No.2006-62021 filed Mar. 8, 2006.

### BACKGROUND

1. Technical Field

The invention relates to an icon generating device, a computer readable medium storing a program for causing a computer to generate an icon and a method for generating an icon indicating presence of a data file.

2. Related Art

In recent years, GUI (Graphical User Interface) technology has been widely used, and object display using an icon image is particularly used. That is, in the GUI environment, it is a common practice to represent objects such as a data file and a folder for storing data files by means of small images referred to as “icons”. Such icon displaying is applied not only to computers, but also to various product fields.

### SUMMARY

According to an aspect of the invention, an icon generating device includes a mode selecting section and an icon generating section. The mode selecting section allows a user to select one display mode for each data file from among a plurality of display modes. The icon generating section generates icon data of each data file, for displaying an icon of the corresponding data file in the display mode selected for the corresponding data file. The icon generating section outputs the generated icon data of each data file.

### BRIEF DESCRIPTION OF THE DRAWINGS

Exemplary embodiments of the invention will be described in detail below with reference to the accompanying drawings wherein:

FIG. 1 is a block diagram to show an example of the schematic configuration of a thermal hydraulic calculation simulator according to an exemplary embodiment of the invention;

FIG. 2 is a view to schematically show a specific example of displayed icon images where display modes of the icon images are unified;

FIG. 3 is a view to schematically show a specific example of displayed icon images where display modes of the icon images are different from each other;

FIG. 4 shows an example of an interface screen displayed on a display screen of a display device 2 by a display mode selecting section 14;

FIG. 5 shows an example where a display section 15 displays an icon image generated by an icon generating section 13;

FIG. 6 shows another example of the interface screen displayed on the display screen of the display device 2 by the display mode selecting section 14;

FIG. 7 shows another example where the display section 15 displays an icon image generated by the icon generating section 13;

FIG. 8 shows further another example of the interface screen displayed on the display screen of the display device 2 by the display mode selecting section 14;

FIG. 9 shows examples of icon images generated by the icon generating section 13;

FIG. 10 shows an example of a data file;

FIG. 11 shows an example of a sub-data file containing at least minimum data for generating icon data;

FIG. 12 is an explanatory view for a thinning-out process, which is performed when the display mode selecting section 14 automatically selects a display mode in accordance with a predetermined rule; and

FIG. 13 shows an example of icon data used for displaying an icon as a moving image.

### DETAILED DESCRIPTION

An icon generating device, a computer readable medium storing a program causing a computer to execute a process for generating an icon, and a method for generating icon according to exemplary embodiments of the invention will be described with reference to the accompanying drawings.

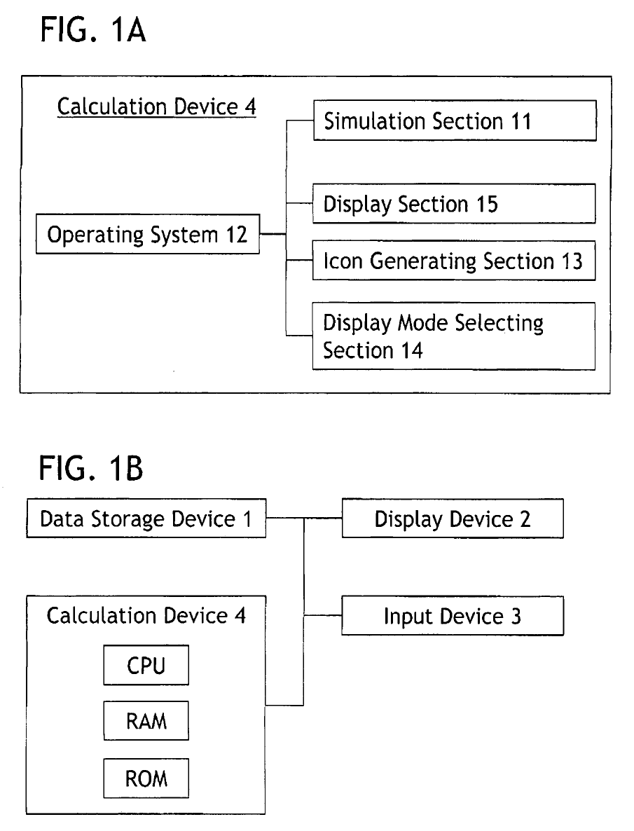

To begin with, the schematic configuration of an icon generating device according to an exemplary embodiment of the invention will be described. In this exemplary embodiment, the icon generating device is applied to a thermal hydraulic calculation simulator for conducting thermal hydraulic calculation simulation. That is, in this exemplary embodiment, the thermal hydraulic calculation simulator is the icon generating device. FIG. 1 is a block diagram to show an example of the schematic configuration of the thermal hydraulic calculation simulator.

FIG. 1B is a block diagram of the thermal hydraulic calculation simulator according to the exemplary embodiment. As shown in FIG. 1B, the thermal hydraulic calculation simulator of the exemplary embodiment includes: a data storage device 1 for storing data files, which is analysis results of thermal hydraulic calculation simulation; a display device 2 for outputting information to an operator (user) of the thermal hydraulic calculation simulator; an input device 3 including a keyboard and/or a mouse, with which the user inputs information into the thermal hydraulic calculation simulator; and a calculation device 4 for executing the thermal hydraulic calculation simulation. The data storage device 1 may be implemented as a hard disk (HDD), RAM or a flash memory. Also, the calculation device 4 may be a computer including CPU (Central Processing Unit), RAM (Random Access Memory), and ROM (Read Only Memory).

FIG. 1A is the functional block diagram of the calculation device 4 shown in FIG. 1B. The calculation device 4 includes a simulation section 11, an operating system 12, an icon generating section 13, a display mode selecting section 14, and a display section 15.

The simulation section 11 conducts thermal hydraulic calculation simulation based on data parameters stored in the data storage device 1 and/or data/parameters input through the input device 3. The thermal hydraulic calculation simulation may be executed using a known technology and therefore, will not be described in detail in this specification. It should be noted that the process performed by the simulation section 11 is not limited to the thermal hydraulic calculation simulation. The simulation section 11 may perform a simulation process based on any other known technology, such as strength analysis simulation or material physical property analysis simulation.

The operating system 12 controls the operation of the entire calculation device 4. The control by the operation system 12 includes, for example, control of data transfer between the calculation device 4 and the data storage device 1, the display device 2 and/or the input device 3.

It is assumed that the icon generating section 13 can generate icon data for displaying icons in plural display modes, respectively. The display mode selecting section 14 selects at least one of the plural display modes, for each data file stored in the data storage section 1. The display mode selecting section 14 may make the selection based on information input through the input device 3, that is, a command entered by the user who operates the input device 3. In other words, the display mode selecting section 14 may allows the user to select at least one of the plural display modes for each data file stored in the data storage device 1. Alternatively, the display mode selecting section 14 may make the section based on pre-setting (default setting). For example, when a data file is to be stored in the data storage device 1, that is, when a data file is to be closed, a display mode in which the display device 2 currently displays the data file may be handled as a default setting. In this case, the display mode selecting section 14 selects the display mode in which the display device 2 currently displays the data file, from the plural display modes. Also, the default setting may be set in advance for each data format of a data file.

Based on contents of data of each data file stored in the data storage device 1 and the at lease one display mode selected for each data file, the icon generating section 13 generates an icon image showing a graph in the selected display mode in which the contents of the data is reflected. In other words, the icon generating section 13 generates icon data of each data file for displaying an icon of each data file in the at least one display mode selected for each data file. Then, the icon generating section 13 may output the generated icon data (icon image) to the operation system 12. The icon generating section 13 may store the generated icon data (icon image) in any of RAM of the calculation device 4 and the data storage device 1. The icon image in which the contents of data are reflected may be a reduced image provided by reducing an entire image specified by the contents of data or a main part enlarged/reduced image provided by changing a scaling factor of a main part of an image specified by the contents of data as described later in detail. It is noted that the icon generating section 13 can generate icon images in the plural display modes for each data file. The plural display modes are different from each other. It is assumed that a data file contains a simulation analysis result in XYZ space as contents of data. In this case, examples of the plural display modes include a display mode for displaying the analysis result on the XY section, a display mode for displaying the analysis result on the YZ section, a display mode for displaying the analysis result on the XZ section. Also, other examples of the plural display modes include a display mode for displaying the analysis result in contour, a display mode for displaying the analysis result in vector, a display mode for displaying the analysis result in particle distribution, a display mode for displaying the analysis result in particle trajectory and a display mode for displaying the analysis result in various graphs such as a scatter chart, a line chart, a bar chart, a pie chart and a radar chart. The particle distribution display is, for example, to display positions of particles, such as toner, which are distributed in space. Also, the particle trajectory display is, for example, to draw a locus of each particle (such as toner) as a line when the particles move. The various graphs may be generated from, for example, results of statistical analysis.

The display mode selecting section 14 may select, for each data file (analysis result), one display mode from the former examples and another one from the latter examples, and the icon generating section 13 may generate icon data of each data file for displaying an icon of each data file in both the selected display modes. It is noted that any display mode of the former examples and any display mode of the latter examples are compatible with each other. Also, if the simulation section 11 performs simulation on the two-dimensional plane, the display mode selecting section 14 selects one display mode from the latter examples but not from the former examples.

The display section 15 displays the icon image of each data file generated by the icon generating section 13 in the display mode selected for each data file through the display mode selecting section 14 on a display screen of the display device 2 as an icon indicating that each data file is present in the data storage device 1. If the operation system 12 can display an icon of each data file based on the icon data of each data file generated by the icon generating section 13, the display section 15 may be not provided in the calculation device 4. For example, if icon data of a data file represents a still icon image and is adapted to the operation system 12, the operation system 12 can display the icon of the data file based on the icon data. To the contrary, if the icon generating section 13 generates icon data of a data file, which represents an icon whose image changes with time like a moving image (generating of such icon data will be described later), most of the known operation systems don't support such icon data. In this case, the display section 15 is provided in the calculation device 4, and displays one of icons of a data file on the display device 2 while changing the currently displayed icon of the data file to another one of the icons of the data file with time.

The simulation section 11, the operating system 12, the icon generating section 13, the display mode selecting section 14, and the display section 15 are implemented when the computer function in the calculation device 4 executes a predetermined program. In this case, the predetermined program may be provided as it is stored on a computer-readable storage medium or may be distributed through wired or wireless communication means before the program is installed in the calculation device 4. That is, the icon generating device described in the exemplary embodiment may be implemented by an icon display program that can be installed in the calculation device 4 of the thermal hydraulic calculation simulator.

Next, an operation example of the thermal hydraulic calculation simulator (which is implemented as the icon generating device and the icon display program according to this exemplary embodiment), that is, a method for generating an icon according to this exemplary embodiment will be described.

In the thermal hydraulic calculation simulator, when the simulation section 11 executes thermal hydraulic calculation simulation, the data storage device 1 stores a data file of the simulation result. At this time, a unique file name may be given to the data file. After the data storage device 1 stores the data file, a user may fetch the stored data file from the data storage device 1 and cause the display device 2 to output the fetched data file. Thereby, the user can examine contents of the data file in more detail, for example. At this time, to specify a data file to be fetched from the data storage device 1, icon images corresponding to data files stored in the data storage device 1 are listed on the display screen of the display device 2 and then, the user is requested to select any icon image from among the listed icon images by operating the input device 3.

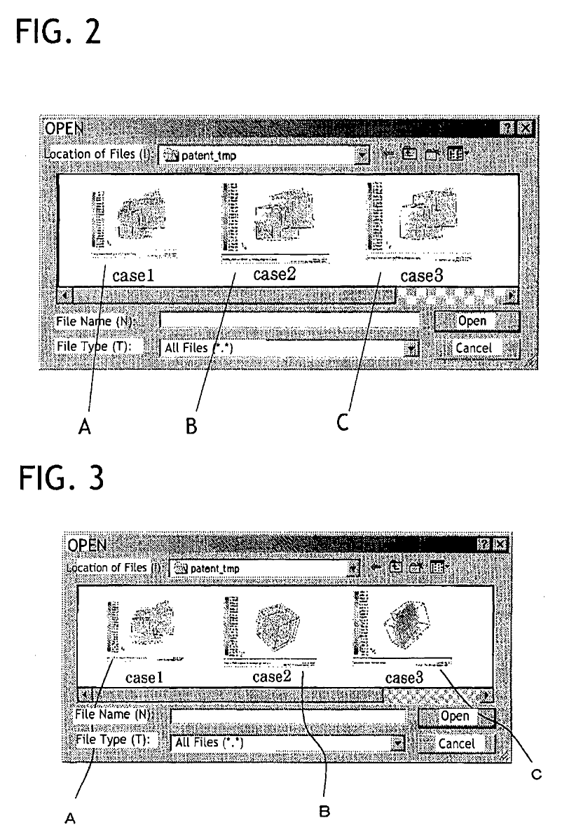

FIG. 2 is a view to schematically show a specific of displayed icon images. In FIG. 2, listed are three icon images A to C corresponding to data files having file names of “case 1,” “case 2,” and “case 3” in a predetermined area of a window screen displayed on the display screen.

To display the icon images A to C as shown in FIG. 2, first the icon generating section 13 generates icon data of the data files “case 1” to “case 3” for displaying respective icon images in a default display mode. The icon generating section 13 generates the icon data (for example, icon images A to C) of each data file after the simulation section 11 outputs each data files as a simulation result, embeds each generated icon data into the corresponding data file and stores the data files in the data storage device 1. Instead of embedding the generated icon data, the icon generating section 13 associates each generated icon data with the corresponding data file and then, stores the icon data in the data storage device. Also, the icon generating section 13 may generate the icon data (for example, icon images A to C) in response to generating of the window screen displayed on the display screen of the display device 2. In any case, when the simulation section 11 outputs a new data file as a simulation result, the icon generating section 13 generates icon data of the new data file before the window screen on which an icon image of the new data file is to be displayed is generated.

The icon generating section 13 generates icon data based on contents of data of the data files so that the contents are reflected in the icon data. Specifically, the icon generating section 13 generates the icon data as follows. For example, when fetching and opening a data file stored in the data storage device 1, the simulation section 11 performs a certain process for the data file if required and then displays the data file on the display screen of the display device 2. A display mode in which the simulation section 11 displays the data file on the display screen at this time depends on a type of application software of the simulation section 11. Generally, the simulation section 11 often displays the contents of data of the data file in the form of diagram, graph and/or table. Therefore, when generating icon data, the icon generating section 13 may generate a bit map image based on the contents of data with using a similar technique to that for outputting (displaying) the contents of data contained in the form of diagram, graph and/or table. The generated bit map image may be a reduced image provided by reducing an entire image specified by the contents of data (an image output in the form of diagram, graph and/or table). Alternatively, the generated bit map image may be a main part scaled image (particularly, main part enlarged image) provided by changing a scaling factor of a main part of the output image (characteristic portion). When the icon generating section 13 generates such a bit map image, the contents of data contained in the corresponding data files are reflected in the generated icon images, respectively. Specifically, the generated icon image enables the user to visually recognize the outline or the features of the contents of data. It is not necessary that the generated icon image is a bit map image. The generated icon image may be of any other data format.

Further, the icon generating section 13 may generate, for a single data file, icon data for displaying icon images in plural display modes. For example, when fetching and a data file fetched from the data storage device 1 and displaying it on the display screen of the display device 2, generally the simulation section 11 often can display the fetched data file in plural display modes, which are different from each other. Specifically, it is assumed that a data file contains the simulation analysis result in XYZ space as contents of data. In this case, the plural display modes include a display mode for displaying the analysis result on the XY section, a display mode for displaying the analysis result on the YZ section, a display mode for displaying the analysis result on the XZ section. Therefore, the icon generating section 13 may be able to generate icon data for displaying icon images in the plural display modes according to a similar concept.

However, if the icon generating section 13 can generate, for one data file, icon data for displaying icon images in plural display modes, it becomes necessary to determine which display mode an icon image is displayed in on the display screen of the display device 2. Since each icon image indicates the presence of the corresponding data file, one icon image should correspond to one data file.

Which display mode an icon image of a data file is displayed in may be determined by either of (i) a first method in which a display mode is selected before icon data is generated and (ii) a second method in which a display mode is selected after icon data is generated. In the first method, the display mode selecting section 14 allows a user to select one display mode for each data file from among the plural display modes, and then the icon generating icon 13 generates icon data of each data file for displaying an icon of each data file in the display mode selected for each data file. A specific example of an interface screen of the display mode selection section 14 will be described later. If the user has not selected any of the plural display modes through the display mode selecting section 14 before generating of icon data, the icon generating section 13 generates icon data for displaying an icon image in the default display mode (default setting). In the first method, the icon generating section 13 generates, for a data file, a single piece of icon data for displaying an icon image in the selected display mode.

In the second method, the display mode selecting section 14 selects one display mode from among the plural display modes, for a data file whose plural icon images have already generated by the icon generating section 13. The display mode selecting section 14 may select the display mode based on a user command (specification) or the default setting. In the second method, the icon generating section 13 generates plural pieces of icon data for displaying icon images of a data file in the plural display modes, respectively and then, the display mode selecting section 14 selects one of the plural pieces of icon data, that is, selects one of the plural display modes. After the selection, the icon generating section 13 deletes the remaining pieces of icon data of the data file other than the selected icon data of the data file.

FIG. 3 shows an example in which display modes are specified by the user for the respective data files. The display modes may be selected by the user desirably for the respective data files. Alternatively, a default display mode (default setting) may be set in advance. For example, the display mode selecting section 14 may use, as the default display mode, a display mode in which displayed is a reduced image of a diagram/graph/table, which was displayed last when contents of data of a data file in question was browsed at the previous time. Alternatively, if a data file has been never displayed, the display mode selecting section 14 may automatically select a display mode, which is set as a default display mode in accordance with a data format of the data file. Further alternatively, the display mode selecting section 14 may allow the user to select a default display mode from among the plural display modes.

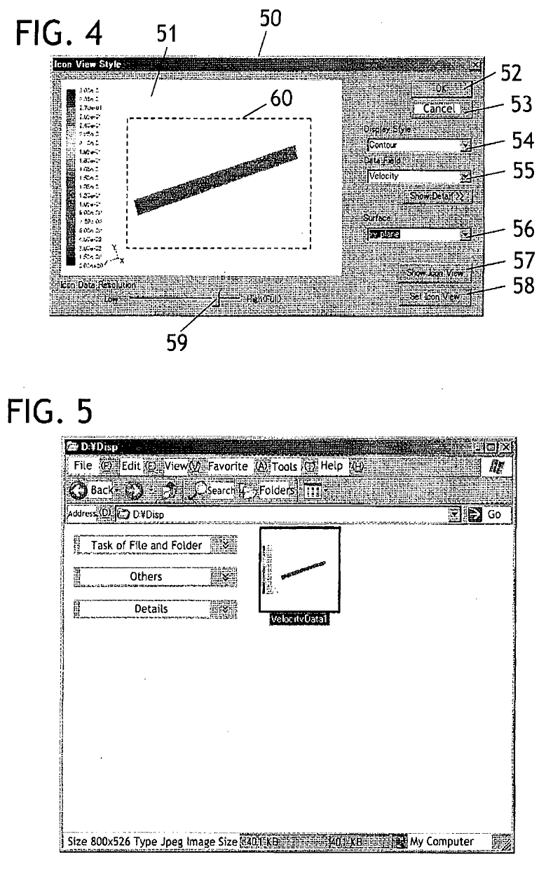

Next, an example of the interface screen of the display mode selecting section 14 will be described below. In order for the user to be enabled to select a display mode, the display mode selecting section 14 displays an interface screen 50 on the display screen of the display device 2 as shown in FIG. 4. The user can operate the interface screen 50 through the input device 3. The interface screen 50 has a sub screen 51, an “OK” button 52, a “cancel” button 53, a pull-down menu 54 for a display style, a pull-down menu 55 for a data field 55, a pull-down menu 56 for a surface, a “Show Icon View” button 57, a “Set Icon View” button 58 and a slide bar 59. The pull-down menu 54 is used to select a display style from among plural display styles. In this example, the plural display styles include (i) displaying in contour, (ii) displaying in vector, (iii) displaying in particle distribution, (iv) displaying in particle trajectory and (v) displaying in graphs. The pull-down menu 55 is used to select one type of data field if a data file for which an icon image is being set contains plural types of data fields as well as coordinate field. For example, when the simulation section 11 performs a thermal hydraulic simulation, the plural types of data fields of a simulation result data file include a flow rate, a pressure, a temperature, a viscosity and a specific gravity. When the simulation section 11 performs a structural analysis simulation, the types of plural data fields include, for example, a displacement, a force, a Young's modulus and Poisson's ratio. Also, when the simulation section 11 performs an electric field analysis simulation, the plural data fields include, for example, a potential, a charge density, a conductivity and a dielectric constant. A specific example of contents of the data file will be described later. The pull-down menu 56 is used to select, from among plural surfaces, a surface along which the sub screen 51 displays a section view of a data file taken. For example, if the simulation section 11 performs some simulation in XYZ space, the plural surfaces include an XY plane, a YZ plane and an XZ plane. The slide bar 59 is used to specify a density of data points (resolution of data points) with which an icon image is generated.

To generate icon data for a data file, at first, the user selects one data file stored in the data storage device 1 through a not-shown user interface (which may be provided by the display mode selecting section 14). The user may select one icon already generated for changing a display mode of the one icon from the current display mode to another display mode. In this case, the mode selecting section 14 reads a data file corresponding to the one icon from the data storage device.

Then, the user selects one display style from the pull-down menu 54 for the display styles, one data filed from the pull-down menu 55 for the data fields and one surface from the pull-down menu 56 for the surfaces. Thereafter, when the user press the “Show Icon View” button 57, the icon generating section 13 generates a temporal icon image of the selected data file based on the selected display style, the coordinate field of the data file, the selected type of data field of the data file and the selected surface. In other words, the temporal icon image shows a section view of the selected type of data field of the data file taken along the selected surface in the selected display style. Then, the display mode selecting section 14 displays the temporal icon image of the selected data file on the sub screen 51. For example, if the user selects “contour” as the display style, “velocity” as the type of data field and “xy plane” as the surface and presses the “Show Icon View” button 57, the temporal icon image of the selected data file shown in FIG. 4 is displayed on the sub screen 51 of the display mode selecting section 14. This temporal icon image shows the velocities (the selected type of data field) on XY plane (the section view taken along the selected surface) in contour (the selected display style). If the user further presses the “Set Icon View” button 58 in the state shown in FIG. 4, the icon generating section 13 stores the temporal icon image in the data storage device 1 as icon data of the selected data file with associating the temporal icon image with the selected data file. Alternatively, the icon generating section 13 may embed the icon data (temporal icon image) into the selected data file and then store the data file in the data storage device 1. Also, the icon generating section 13 may extract, from the data file, the coordinate field (described later) and the selected one type of data field, and store the extracted data as the icon data. That is, in this exemplary embodiment, the “icon data” is not limited to image data such as bitmap, jpeg or gif, but may be data (extracted data), which are required to generate an icon.

When a folder including a data file is opened after the icon data of the data file is generated, the display section 15 displays a screen shown in FIG. 5 on the display device 2. That is, the display section 15 displays the icon image based on the icon data of the data file. In this example, the icon image shown in FIG. 5 is a reduce image of the entire temporal icon image displayed in the sub screen 51 of FIG. 4. However, the icon images (icon data) generated by the icon generating section 13 are not limited thereto, but may be a reduced or enlarged image of a main portion 60 of the temporal icon image shown in FIG. 4. Furthermore, the display mode selecting section 14 may allow the user to set a range of the main portion 60 in the sub screen desirably.

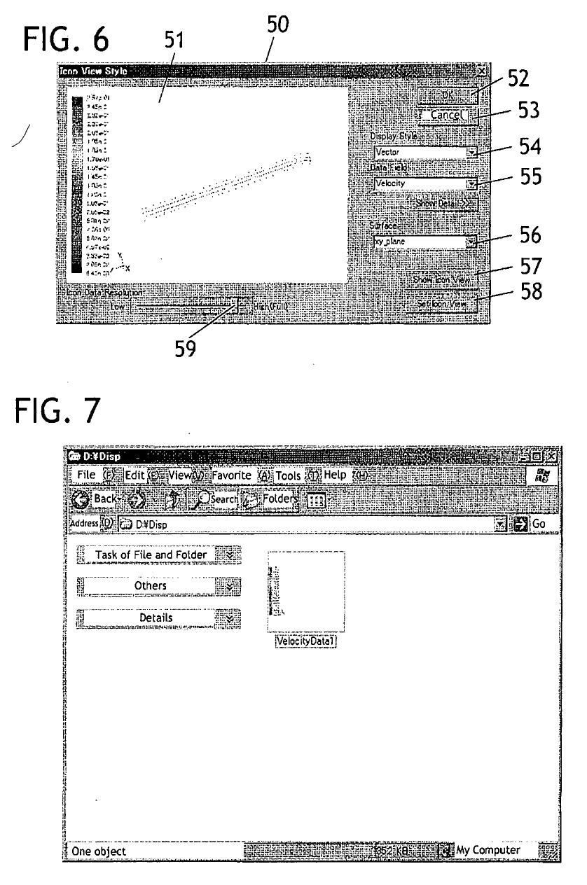

On the other hand, if the user selects “vector” as the display style, “velocity” as the type of data field and “xy plane” as the surface and presses the “Show Icon View” button 57, the temporal icon image of the selected data file shown in FIG. 6 is displayed on the sub screen 51. If the user further presses the “Set Icon View” button 58 in the state shown in FIG. 6, the icon generating section 13 stores the temporal icon image in the data storage device 1 as icon data of the selected data file with associating the temporal icon image with the selected data file. When a folder including the selected data file is opened, the display section 15 displays a screen shown in FIG. 7 on the display device 2.

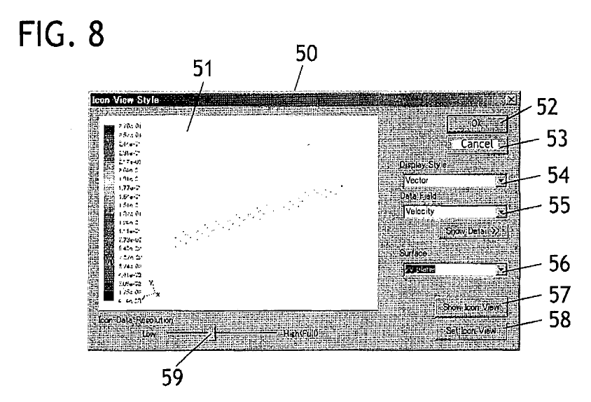

Also, if the user slides the slide bar 59 from the rightmost side (which indicates the highest density in data points) to a middle position in the state shown in FIG. 6 and then presses the “Show Icon View” button 57, the temporal icon image of the selected data file shown in FIG. 8 is displayed on the sub screen 51. In FIG. 8, the temporal icon image is drawn with less data points than those used in FIG. 6.

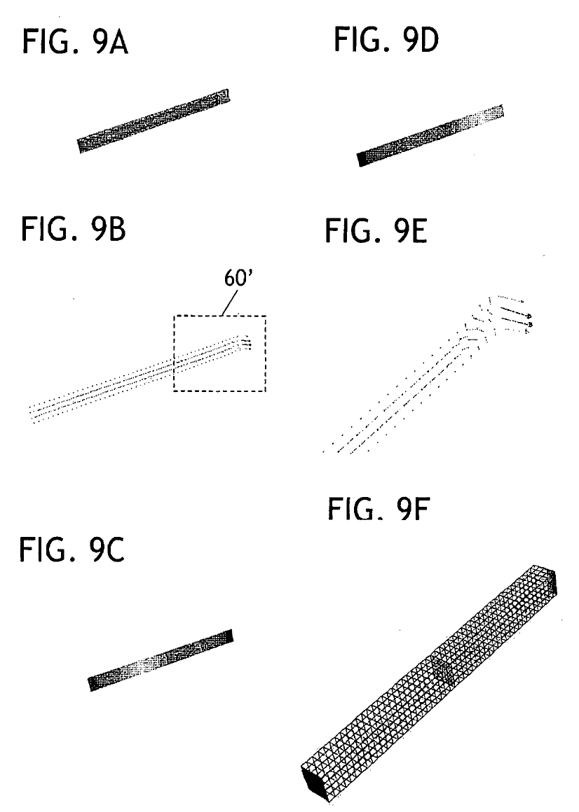

Other examples of icon images generated by the icon generating section 13 are shown in FIG. 9. FIG. 9A shows an icon image, which is generated by selecting the “contour” as the display style, the “velocity” as the type of data field and selecting “xy plane” as the surface. That is, the icon image shown in FIG. 9A is the same as the temporal icon image displayed on the sub screen 51 in FIG. 4. FIG. 9B shows an icon image, which is generated by selecting the “vector” as the display style, the “velocity” as the type of data field and selecting “xy plane” as the surface. The icon image shown in FIG. 9B is different from that shown in FIG. 9A in the display style. FIG. 9C shows an icon image, which is generated by selecting the “contour” as the type of display style, the “temperature” as the data field and selecting “xy plane” as the surface. The icon image shown in FIG. 9C is different from that shown in FIG. 9A in the selected type of data field. FIG. 9D shows an icon image, which is generated by selecting the “contour” as the display style, the “pressure” as the data field and selecting “xy plane” as the surface. FIG. 9E shows an icon image generated by enlarging a part of the icon image shown in FIG. 9B. That is, when the user sets the main portion 60′ as shown in FIG. 9B through the display mode selecting section 14, the icon generating section 13 generates the icon image shown in FIG. 9E based on the icon image shown in FIG. 9B. FIG. 9F shows an icon image, which is generated by selecting the “contour” as the display style, the “pressure” as the type of data field and selecting “yz plane and two other parallel planes” as the surface. In this example, the display mode selecting section 14 may allow the user to specify the two other planes parallel to the yz plane.

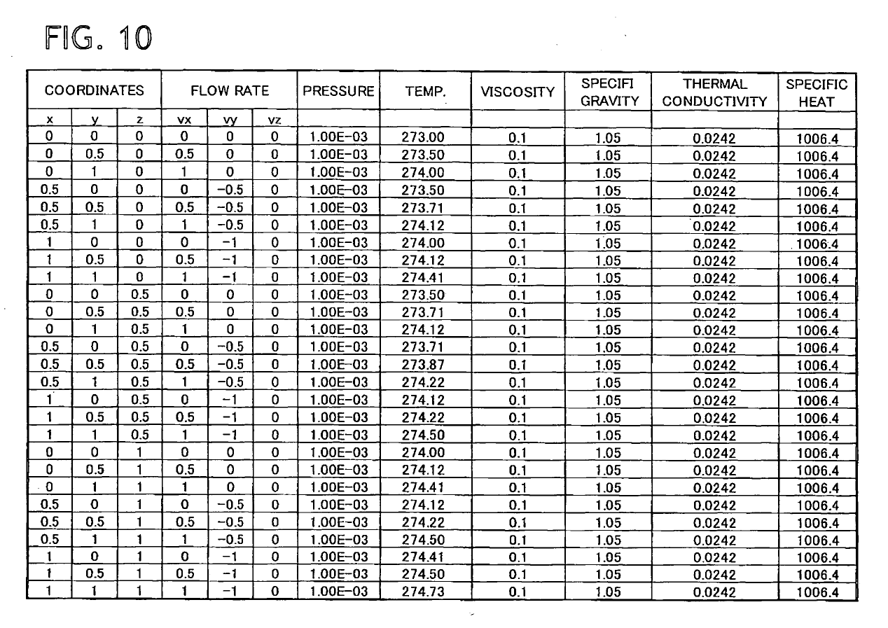

Next, a specific example of the data file will be described with reference to FIG. 10. The data file shown in FIG. 10 has a coordinate field (including x, y and z coordinates) and seven types of data fields (that is, flow rate, pressure, temperature, viscosity, specific gravity, thermal conductivity and specific heat). If the user selects this data file, the seven types of data fields described above are listed in the pull-down menu 55, and at least three surfaces, that is, an XY plane, a YZ plane and an XZ plane are listed in the pull-down menu 56.

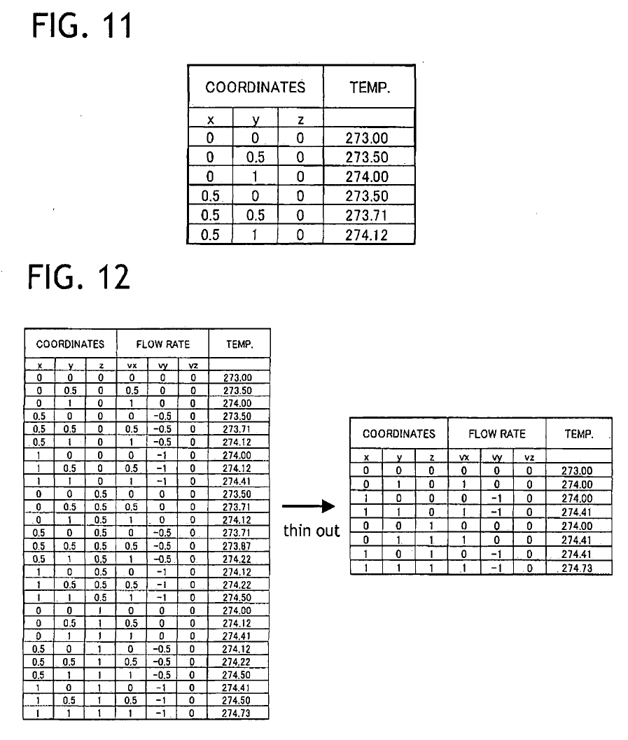

When the user selects the “contour” from the pull-down menu 54, the “temperature” from the pull-down menu 55 and the “XY plane” from the pull-down menu 56 and then press the “Set Icon View” button 58, the icon generating section 13 may generates a sub-data file containing at least minimum data for generating an icon image, for example as shown in FIG. 11 and store the sub-data file as the image data in the data storage device 1. The sub-data file shown in FIG. 11 contains the coordinate field and the selected data field (that is, the “temperature” field). The icon generating section 13 may generate the sub-data file as a different file from icon data (image data such as bmp, jpeg or gif).

When one display mode (one combination of the display style, the type of data field, the surface, the density of data points and the main portion 60) is thus selected and set for each data file through the display mode selecting section 14, the display section 15 displays an icon image of each data file in the display mode selected for each data file. The display section 15 displays, in a predetermined area of a window screen displayed on the display device 2, an icon image of each data file based on the icon data generated by the icon generating section 13 for displaying an icon image of each data file in the display mode selected through the display mode selecting section 14. The displayed icon images indicate that the corresponding data files are present in the data storage device 1. Accordingly, for example, if three data files exist in the data storage device 1, three icon images A to C corresponding to the data files are displayed.

By the way, the listed icon images A to C are displayed in the display modes selected for the respective data files through the display mode selecting section 14. However, the same display mode may not be selected for all the icon images. On the other hand, when the contents of data contained in the data files relate to each other, if the display modes of the icon images A to C are unified, a user may be enabled to easily understand the correlation among the data files.

Then, to list the icon images A to C, the display section 15 may unify the display modes of the icon images A to C and then display the icon images on the display device 2. In FIG. 2, icon images are displayed in the unified display mode. That is, FIG. 2 shows that the icon images corresponding to the data files of “case 1,” “case 2” and “case 3” are displayed in the same display mode.

If the user operates the input device 3 in a predetermined manner after the icon images A to C are displayed (for example, as shown in FIG. 3), the display section 15 may unify the display modes of the icon images A to C in response to the user's predetermined operation. The display section 15 may request the icon generating section 13 to generate icon data for displaying an icon image of each data file in the unified display mode, if necessary. Furthermore, if the user has already instructed to unify display modes of icon images through the input device 3 before the icon images A to C are displayed, the display section 15 may unify the display modes at the time when the icon images A to C are displayed. For example, the display section 15 may add “unify display modes of icons” to the “view” menu of the Explorer of Windows®. In this case, when the user selects the “unify display modes of icons” function, the display section 15 may request the user to input what display mode (e.g., display style, type of data field, surface and density of data points) the display modes of the icon images are unified to.

Alternatively, the display section 15 may unify the display modes of the icon images to a display mode of one of the displayed icon images A to C in accordance with a user's command entered through the input device 3. That is, if the user selects one of the icon images A to C by operating the input device 3, the display section 15 unifies the display modes of the icon images A to C in the display mode of the selected one. If the user has not selected a unified display mode but instructs to unify display modes of icon images, the display section 15 may unify the display modes of the icon images to a predetermined display mode. The predetermined display mode may be a display mode of an icon image displayed at the left end on the screen at the time when the user instructs to unify. Alternatively, the predetermined display mode may be set in advance as a default display mode.

Thus, the display modes of the icon images A to C can be changed still after the icon images A to C are displayed. It is noted that changing of the display modes is not limited to unifying of the display modes of the icon images A to C. That is, if the display modes are not unified, the display modes of the icon images A to C may be changeable after the icon images A to C are displayed. In this case, if the user selects one of the listed icon images A to C by operating the input device 3 and specifies a new display mode, the icon generating section 13 again generates icon data for displaying in the new display mode an icon image of a data file corresponding to the selected one of the icon images A to C.

Also, the display section 15 may changes one icon image for a certain data file to another icon image for the certain data file with time, like GIF animation. In order to display the icon image in the animation manner, the user selects different display modes (that is, different combination of the display style, the type of data field, the surface, the density of data points and the main portion 60) for the data file through the display mode selecting section 14 in advance so that the icon generating section 13 generates plural pieces of icon data for the data file. For example, if the user makes a selection shown in FIG. 4 as one display mode and also makes another selection shown in FIG. 6 as another display mode, the icon generating section 13 generates two pieces of icon data for the single data file. In this case, the display section 15 displays changes between the two icon images of the data file with time.

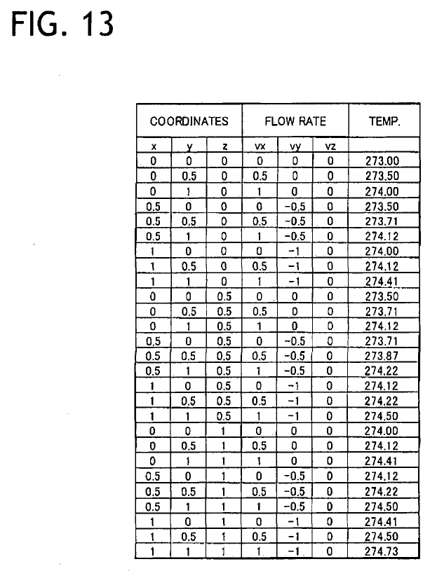

The icon generating section 13 may not generate image data (e.g., bitmap, jpeg or gif) as the icon data, but generate the sub-data file as described above. For example, it is assumed that the user wants to display an icon of a data file with an icon being changed between the flow rate distribution and the temperature distribution with time. In this case, the user selects the “flow rate” and the “temperature” from the pull-down menu 55. The icon generating section 13 extracts the coordinate field, the “flow rate” field and the “temperature” field from the data file, for example, shown in FIG. 10 to generate a sub-data file shown in FIG. 13. Then, the icon generating section 13 stores the generated sub-data file in the data storage device as the icon data. When displaying an icon of the data file, the display section 15 requests the icon generating section 13 to generate an icon of the data file from the sub-data file and then displays, on the display screen of the display section 2, the icon of the data file generated by the icon generating section 13.

Also, if the display mode selecting section 14 automatically changes selection of the display mode of the icon image according to a predetermined rule with time, the icon generating section 13 generates icon data in accordance with the automatic selection made by the display mode selecting section 14 and the display section 15 displays a moving image as an icon image indicating the presence of a data file.

To change the display modes of the icon images A to C (see FIGS. 2 and 3) with time with the display mode selecting section 14 automatically selecting display modes according to the predetermined rule, the icon generating section 13 generates icon data each time the display mode selecting section makes the automatic selection. Thus, if the display mode is frequently changed, it is concerned that the processing load on the icon generating section 13 will increase. Thus, the icon generating section 13 may generate icon data in the following manner.

For example, if the icon generating section 13 generates a bitmap image as icon data, the icon generating section 13 may store the generated bitmap image for reuse. If the bitmap image is reused, it is made possible to lighten the processing load on the icon generating section 13. However, if the display mode selecting section 14 makes the automatic selection and the bitmap image is stored and reused, it is not easy for the icon generating section 13 to deal with changing of the display mode with time as described above. Then, to deal with changing of the display mode with time, the icon generating section 13 may extract the minimum data required for generating icon data from a data file and store the extracted data.

Specifically, the thermal hydraulic calculation simulator is configured so that the icon generating section 13 includes a data extraction section for extracting at least the minimum data required for generating an icon data from a data file and a data storage section for storing the minimum data extracted by the data extraction section. For example, the data extraction section may extract at least the minimum data from the data file in accordance with a density of data points specified by the above described predetermined rule. If the specified density of data points is equal to a half of the maximum density, the data extraction section may thin out data in the data file as shown in FIG. 12. When the display section 15 displays an icon image, the icon generating section 13 generates the icon data using the minimum data stored in the data storage section. That is, in the case where the display mode selecting section 14 automatically selects a display mode in accordance with the predetermined rule and the display mode of the icon image is changed with time, in order to lower the icon re-generating load on the icon generating section 13, the icon generating section 13 is provided with a function of storing the minimum data, for generating icon data, obtained by thinning out original data of a data file.

With this configuration, while it is made possible to easily and flexibly deal with changing of the display mode of the icon image with time, an amount of scan data to re-generate the icon image is reduced. Consequently the image re-generation processing load on the icon generating section 13 can be lowered. The data extraction section and the data storage section may be implemented by executing a predetermined program like the sections 11 to 15. A storage area of the minimum data is not limited. If a relation with the original data file is identified, the minimum data may be stored together with the data file or may be stored separately from the original data file. Further, the contents of data extracted as the minimum data are not limited if they are the minimum required for generating the icon image.

Although the exemplary embodiments of the invention has been described, it is to be understood that the invention is not limited to the specific embodiment thereof and various modifications and changes may be made without departing from the spirit and the scope of the invention. For example, in the description of the exemplary embodiment, the case where the invention is applied to the thermal hydraulic calculation simulator for conducting thermal hydraulic calculation simulation is taken as an example. However, the invention is applied not only to an apparatus for performing simulation analysis processing other than thermal hydraulic calculation simulation, but also to a diagnosis apparatus for performing various types of diagnosis processing and a measuring apparatus for conducting various types of measurements if the apparatus has a function of displaying the presence of a data file about the processing result (the diagnosis result, the measurement result, etc.,) according to an icon image, whereby the facility of grasping the contents of data based on the icon image can be improved.

What is claimed is:

1. An icon generating device comprising:
a mode selecting section that allows a user to select one display mode for each data file from among a plurality of display modes; and
an icon generating section that generates icon data of each data file, for displaying an icon of each data file in the display mode selected for each data file, wherein the icon generating section outputs the generated icon data of each data file.

2. The device according to claim 1, wherein the icon of each data file includes a graph, which is generated based on each data file.

3. The device according to claim 1, wherein:
the plurality of display modes include:
a first display mode for displaying a data file in contour;
a second display mode for displaying a data file in vector;
a third display mode for displaying a data file in particle distribution;
a fourth display mode for displaying a data file in particle trajectory; and
a fifth display mode for displaying a data file in a graph.

4. The device according to claim 1, wherein:
each data file contains coordinate values and plural kinds of data values,
the mode selecting section allows the user to select one kind of data values for each data file from among the plural kinds of data values, as the display mode, and
the icon generating section generates the icon data of each data file based on the coordinate values of each data file and the one kind of data values selected for each data file.

5. The device according to claim 2, wherein:
the mode selecting section allows the user to input a density of data points to be displayed, for each data file as the display mode, and
the icon generating section generates the icon data of each data file for displaying the icon of each data file with the density input for each data file.

6. The device according to claim 1, wherein:
the mode selecting section allows the user to select another display mode for one generated icon data from among the plurality of display modes, and
the icon generating section changes the display mode of the data file corresponding to the one generated icon to the selected other display mode.

7. The device according to claim 5, wherein:
each data file contains coordinate values and data values,
the icon generating section thins out the coordinate values and the data values of each data file in accordance with the density input for each data file, and
the icon generating section generates the icon data of each data file so that the icon data of each data file contains the thinned out coordinate values and the thinned out data values.

8. The device according to claim 1, further comprising:
a display section, wherein:
the mode selecting section allows the user to select two or more display modes for each data file from among the plurality of display modes,
the icon generating section generates the icon data of each data file, for displaying icons of each data file in the selected display modes,
the icon generating section outputs the generated icon data of each data file to the display section,
the display section displays one of the icons of each data file on a display device while changing the currently displayed icon of each data file to another one of the icons of each data file with time.

9. The device according to claim 8, wherein:
the icon generating section generates the icon data of each data file so that the icon data of each data file contains data values required to display the icons of each data file in the selected two or more display modes.

10. A computer readable medium storing a program causing a computer to execute a process for generating an icon, the process comprising:
allowing a user to select one display mode for each data file from among a plurality of display modes;
generating icon data of each data file, for displaying an icon of each data file in the display mode selected for each data file; and
outputting the generated icon data of each data file.

11. The medium according to claim 10, wherein the icon of each data file includes a graph, which is generated based on each data file.

12. The medium according to claim 10, wherein:
the plurality of display modes include:
a first display mode for displaying data file in contour; and
a second display mode for displaying data file in vector.

13. The medium according to claim 10, wherein:
each data file contains coordinate values and plural kinds of data values,
the allowing allows the user to select one kind of data values for each data file from among the plural kinds of data values, as the display mode, and
the generating generates the icon data of each data file based on the one kind of data values selected for each data file.

14. The medium according to claim 10, wherein:
the allowing allows the user to select two or more display modes for each data file from among the plurality of display modes,
the generating generates the icon data of each data file, for displaying icons of the corresponding data file in the selected display modes, and
the process further comprises displaying one of the icons of each data file on a display device while changing the currently displayed icon of each data file to another one of the icons of each data file with time.

15. A computer data signal embodied in a carrier wave for enabling a computer to perform a process for generating an icon, the process comprising:
allowing a user to select one display mode for each data file from among a plurality of display modes;
generating icon data of each data file, for displaying an icon of each data file in the display mode selected for each data file; and
outputting the generated icon data of each data file.

16. A method for generating an icon, comprising:
allowing a user to select one display mode for each data file from among a plurality of display modes;
generating icon data of each data file, for displaying an icon of each data file in the display mode selected for each data file; and
outputting the generated icon data of each data file.

17. An icon generating device comprising:
a display mode determining section that selects one display mode from among a plurality of display modes; and
a icon generating section that generates an icon image showing a graph in the selected display mode, based on a data content of a data file so that the data content is reflected in the generated icon.

18. The method according to claim 17, further comprising:
an display section that displays the icon image, which is generated by the icon generating section and which shows the graph in the selected display mode, as an icon indicating presence of the data file.

19. The device according to claim 17, wherein the icon generating section generates a reduced image obtained by reducing an entire image determined by the data content as the icon image in which the data content of the data file is reflected.

20. The device according to claim 17, wherein the icon generating section generates a main part scaled image obtained by changing a scaling factor of a main part of an image determined by the data content as the icon image in which the data content of the data file is reflected.

21. The device according to claim 18, wherein when displaying icon images of a plurality of data files on a single screen, the display section unifies display modes for the respective icon images to one of the display modes for the respective icon images or to a predetermined display mode, and displays the icon images in the unified display mode.

22. The device according to claim 18, wherein:
the display mode determining section selects two or more display modes from among the plurality of display modes so that the display mode selected for the icon image changes with time, and
the display section displays a moving image as the icon image indicating the presence of the data file when the user selects, through the display mode determining section, two or more display modes so that the display mode selected for the icon image changes with time.
